(19) United States
(12) Patent Application Publication
(10) Pub. No.: US 2025/0322661 A1
(43) Pub. Date: Oct. 16, 2025

(54) UNIFIED SYSTEM FOR VIDEO CONTENT INTERPRETATION VIA ZERO-SHOT INFERENCE AND TEXTUAL-CONTEXT-BASED AUGMENTED RETRIEVAL

(71) Applicant: HITACHI, Ltd., Tokyo (JP)

(72) Inventors: Riu HIRAI, Cupertino, CA (US); Sudhanshu GAUR, Cupertino, CA (US)

(21) Appl. No.: 18/636,919

(22) Filed: Apr. 16, 2024

(51) Int. Cl. G06V 20/40; G06F 40/58; G06V 10/70

(52) U.S. Cl. CPC G06V 20/44; G06V 10/768; G06V 20/41; G06F 40/58

(57) ABSTRACT

Systems and methods for interactive time series analysis, involving a database managing a plurality of videos; a processor, configured to, for receipt of a query, calculate probability information of at least one object on each frame of a video from the plurality of videos related to the query; calculate a state of the at least one object for a specified time based on the probability information from past to the specified time; and input the state at the specified time to a large language model (LLM) configured to output an analysis and prediction in a natural language output responsive to the query.

### BACKGROUND

### Field

The present disclosure is generally directed to factory systems, and more specifically, to video content interpretation and textual context based augmented retrieval through use of Large Language Models (LLMs).

### Related Art

In the context of manufacturing, frequent production halts due to human errors have posed significant challenges. Historically, records of individual worker behaviors and patterns have been kept on paper and have not been digitized, leaving a gap in efficiently understanding and preventing these human errors.

Expectations for the digitization of human behavior patterns on the manufacturing floor are growing with the goal of mitigating plant stoppages and increasing operational efficiency. Recent advances in artificial intelligence (AI), particularly machine learning models for video analytics, are beginning to address this need. These advances go beyond the analysis of a single image to enable contextual analysis of video frames, providing nuanced and accurate interpretation of visual data in real time. The application of supervised learning AI, which has long been studied, has shown some effectiveness in digitizing these patterns, leading to the analysis of production bottlenecks and the potential for productivity maximization. However, this approach has challenges, such as the significant effort required for optimization of AI models and the difficulty of horizontal deployment across different sites.

In addition, foundation models, such as Large Language Models (LLMs), Contrastive Language-Image Pre-training (CLIP) and so on, offer exciting opportunities for zero-shot learning and can be used on new data without specific training. They have demonstrated promising applications in classification, object recognition, and image captioning. This can significantly reduce the time and resources required to train and deploy the model. Nevertheless, the dependence on the quality of the input data means that the output may contain irrelevant or inaccurate information, which poses challenges to accuracy and reliability. Especially, accuracy is not high for video analysis, for example, towards video with complicated backgrounds where objects not subject to detection are included.

In this backdrop, the manufacturing industry is undergoing a transformation, where digitizing human action patterns through optimized AI models could unlock new levels of productivity and operational insight. The balance between the high accuracy of site-optimized AI and the broad applicability but lower precision of foundational models represents a pivotal area of development.

Existing technologies using foundation models primarily focus on object detection and image classification without deeply integrating contextual and temporal analysis. For instance, conventional machine learning models might identify objects or anomalies within a single frame but struggle with understanding sequences or the significance of changes over time. Related art implementations involve various approaches to video analysis and anomaly detection, but they often lack the integration of natural language processing (NLP) for enhanced contextual understanding and interactivity. Products and services in the market might offer basic video analytics, but do not fully exploit the synergy between visual data interpretation and natural language understanding.

In a related art implementation, there is a method for querying video data. The video data is divided on a per-shot basis, based on image frames, audio data, and caption data associated with the same caption, and feature quantities for each shot are extracted as vector information. A feature vector for the entire video data is generated by processing the vector information of each shot together through a multilayer neural network. The most suitable video data is selected from the video storage based on the similarity with the comparison feature vector. Such related art implementations do not conduct time-series analysis on a per-frame basis.

In another related art implementation, there is a computer vision system that learns directly from text descriptions, bypassing the need for labeled data. By pre-training on 400 million web-collected image-text pairs, such a related art model uses natural language to identify and describe visual concepts, enabling zero-shot classification across diverse tasks without task-specific training. This related art method matches the performance of traditional, fully supervised models like ResNet-50 on ImageNet, demonstrating significant adaptability and efficiency. However, this approach does not involve time-series information processing, focusing instead on leveraging natural language for visual recognition.

### SUMMARY

Example implementations described herein seek to navigate these challenges, offering a novel solution that leverages the strengths of both approaches to minimize human errors and enhance manufacturing efficiency. The example implementations described herein can be applied not only to the digitization of human behavior, but also to the digitization of other devices, materials, autonomous guided vehicles (AGVs) and so on. For ease of understanding, the example implementations described herein are described with respect to the digitization of human behavior, but is not limited thereto.

A major challenge that has not been solved by the related art is the limited ability to perform detailed, context-aware analysis of the sequence of events in video data. Existing solutions can perform comprehensive semantic extraction and scene classification of video, but they cannot dynamically interpret the meaning of events as they occur from moment to moment over time or provide a conversational interface for abstract and unambiguous queries about time. Example implementations described herein aim to fill this gap by providing time series analysis of video data by integrating CLIP for visual data interpretation and LLM for context-rich natural language interaction.

### BRIEF DESCRIPTION OF DRAWINGS

FIG. 1 illustrates an example system for interactive time series analysis that includes steps, in accordance with an example implementation.

FIG. 2 illustrates an interactive time series analysis system tailored for analyzing the Mean Time to Detection (MTTD) of a designated process, in accordance with an example implementation.

FIG. 3A illustrates a sequence diagram associated with the system described herein, in accordance with an example implementation.

FIG. 3B illustrates an example question and answer tree to obtain relevant information, in accordance with an example implementation.

FIG. 4 illustrates an example of pre-processing, in accordance with an example implementation.

FIG. 5 illustrates the MTTD measurement being queried, in accordance with an example implementation.

FIG. 6 illustrates an example of the user interface for the system for interactive time series analysis, in accordance with an example implementation.

FIG. 7A illustrates an example of the execution of the contextual information calculation unit, in accordance with an example implementation.

FIG. 7B shows the probability columns when this scene is textualized by the each event probability calculation unit, in accordance with an example implementation.

FIGS. 7C and 7D show examples of calculations by the contextual information calculation unit, in accordance with an example implementation.

FIG. 8 illustrates another example implementation for an interactive timeseries system designed for inventory management within the XYZ process.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination, and the functionality of the example implementations can be implemented in any manner in accordance with the desired implementation.

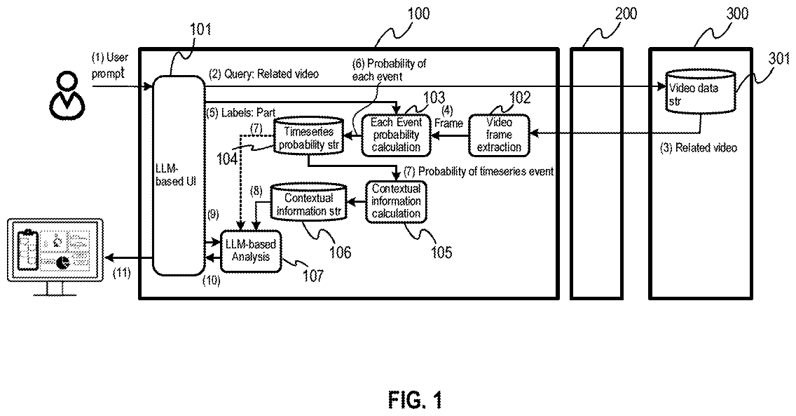

FIG. 1 illustrates an example system for interactive time series analysis that includes steps, in accordance with an example implementation. Example implementations described herein involve innovative system that combines CLIP (Each Event probability calculation unit 103) for advanced image analysis with Large Language Models (LLMs: LLM-based Analysis 107) to offer a Retriever-Augmented Generation (RAG) based chat system for interactive time series analysis. For example, by identifying peaks and troughs in the probabilities of events across video frames on contextual information calculation unit 105 and enriching these insights with manufacturing context information, the system allows users to interactively query the system using natural language. This dual approach not only enhances the accuracy of event detection and classification in video data, but also revolutionizes the way users can interact with and understand the analysis, enabling queries like “show me frames with potential equipment issues” or “when was the last time a part wasn't present?” to be answered comprehensively and conversationally.

As shown in FIG. 1, example implementations involve a system for interactive time series analysis that includes steps for calculating probability information of objects on each frame of video data, calculating the state of the objects at a specified time based on probability information from past to present, and inputting the state at a specified time into a natural language model (LLM), thereby enabling analysis and prediction based on natural language.

Depending on the desired implementation, the calculation of the state at the specified time can include functions for integrating past and present probability information.

Depending on the desired implementation, the LLM can be configured to generate dialogue responses based on the inputted probability information and state information.

Depending on the desired implementation, the step of calculating the state at the specified time uses a probability model that considers the dynamic changes of the object.

Depending on the desired implementation, the calculation of the state at the specified time can include computing/predicting future probability information, and based on this future probability information, facilitate analysis and prediction of future events or states by using the LLM.

Depending on the desired implementation, the LLM can be configured to dynamically adjust responses according to the context of the generated dialogue responses and user requests for additional information.

Depending on the desired implementation, the LLM is configured to present the predicted information based on future probability information as warnings, suggestions, or action directives to the user.

Depending on the desired implementation, there can be a pre-processing module that optimizes label information before calculating object probability information, thereby improving the accuracy of subsequent analysis and prediction.

Depending on the desired implementation, the LLM can utilizes Retriever-Augmented Generation (RAG) approach for handling complex queries, enabling the integration of contextual information from external knowledge bases to enrich dialogue responses.

Depending on the desired implementation, there can also be a feedback mechanism that allows the system to learn from user interactions and refine its predictive models over time, thereby enhancing the relevance and accuracy of its outputs.

In the context of image processing and computer vision, objects within an image frame refer to distinct items, figures, or areas that are of interest for analysis or classification. These objects can be anything from people, vehicles, animals, to more abstract concepts like shapes or text. Labels, on the other hand, are the tags or names assigned to these objects to identify them as belonging to particular categories or classes. For example, in a street scene, objects like cars, pedestrians, and traffic lights could be labeled accordingly based on their appearance and characteristics in the image.

In classification problems, probability information refers to the likelihood or confidence that a given object or instance belongs to a particular class or category. This information is typically output by a classification model, such as a neural network, which processes the input data (e.g., an image or a set of features) and predicts the class memberships for each object. The probabilities are often expressed as values between 0 and 1, where a higher value indicates a higher confidence in the classification. For instance, a model might predict that an image of a cat has a 95% probability of being in the “cat” category and a 5% probability of being in the “dog” category.

State information derived from time series data encompasses the conditions or attributes of a system or process at different points in time, based on historical and current data. In the context of video analysis or sequential data processing, this can involve understanding how the attributes of objects (such as their position, motion, or appearance) change over time. By analyzing these dynamic changes, it is possible to infer the current state of the system and predict future states. For example, by tracking the movement of a vehicle across consecutive frames in a video, one can calculate its speed, direction, and predict its future location; when using a moving camera, such as an AGV-mounted camera, the position extracted from the AGV can be synchronized with probabilistic information to correct the camera-subject relationship between the camera and the vehicle can also be compensated.

Retriever-Augmented Generation (RAG) is a technique in natural language processing (NLP) that combines the retrieval of relevant information from a large corpus of text (the retriever part) with a generative model capable of producing human-like text based on the retrieved information (the generation part). This approach allows the model to pull in external knowledge that is pertinent to the current context or query, thereby enhancing the quality and relevance of the generated responses. In practical applications, RAG can be used to answer complex questions, generate detailed explanations, or even create content by accessing and synthesizing information from diverse sources. For example, when asked a specific question, a RAG system could search a database of documents to find relevant information and then use that information to construct a coherent and informative answer.

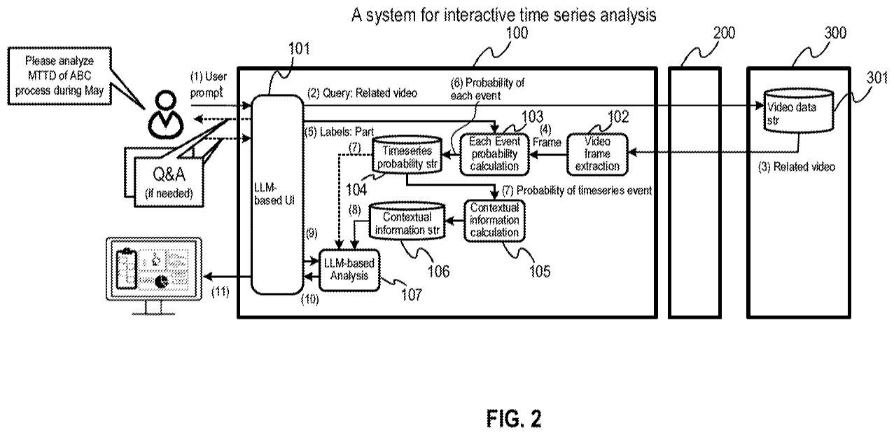

FIG. 2 illustrates an interactive time series analysis system tailored for analyzing the Mean Time to Detection (MTTD) of a designated process, in accordance with an example implementation. The example of FIG. 2 has a designated process referenced as the “ABC” process, and specifically during the month of May. The system is composed of three principal components: the time series analysis component 100, the data communication component 200, and the large-scale data storage 300.

Input of user prompt (1) is the starting point. If the initial data input is insufficient, the system can request additional information via the LLM-based user interface (UI) 101. This interactive Q&A (if necessary) ensures that the system has all the information it needs to proceed with the analysis; RAG system can also be used to refer to external knowledge. The UI 101 queries the large data storage 300 for relevant video data (3) related to the ABC process. The query (2) is entered into the video data storage 301 via the data communication component 200 to facilitate the transfer of any data from the storage 300 to the analysis component 100.

Video frame extraction unit 102 splits the video data into individual image frames (4). These frames, along with labels for MTTD (5), enter the probability calculation unit 103 for each event. Here, the probability of each event (6) is determined. For MTTD analysis, labels for MTTD (5) could be the red (or green) signals and the worker responding to an issue.

The system further incorporates a time series probability storage 104, which stores time series probability strings (6) from past to current. This information, combined with contextual strings (7), is processed in the contextual information calculation unit 105 to create a comprehensive information that encompasses both probability and contextual nuances, such as identifying key moments like sharp peaks or troughs in event probabilities or worker response times, which is vital contextual data for the MTTD evaluation. The information would be stored into contextual information storage 106.

The LLM-based analysis unit 107 then utilizes this rich contextual information (8) and initial user prompt with relevant information (9) to conduct a detailed timeseries analysis. This analysis might generate analyzed data like MTTD-related insights (10).

Ultimately, the LLM-based UI 101 employs the analysis results to generate dynamic dialogue responses (11) to the user like visualization. This could involve interactive feedback, such as clarifying the significance of signal colors in the operational context or explaining the MTTD metric within the system. Additionally, the system's user-friendly interface allows for complex time series data to be easily inputted and interpreted, thereby aiding in the optimization of decision-making processes related to the ABC process. Although omitted from the description, external data such as Programmable Logic Controllers (PLCs) can be used as input to the system in addition to probability information.

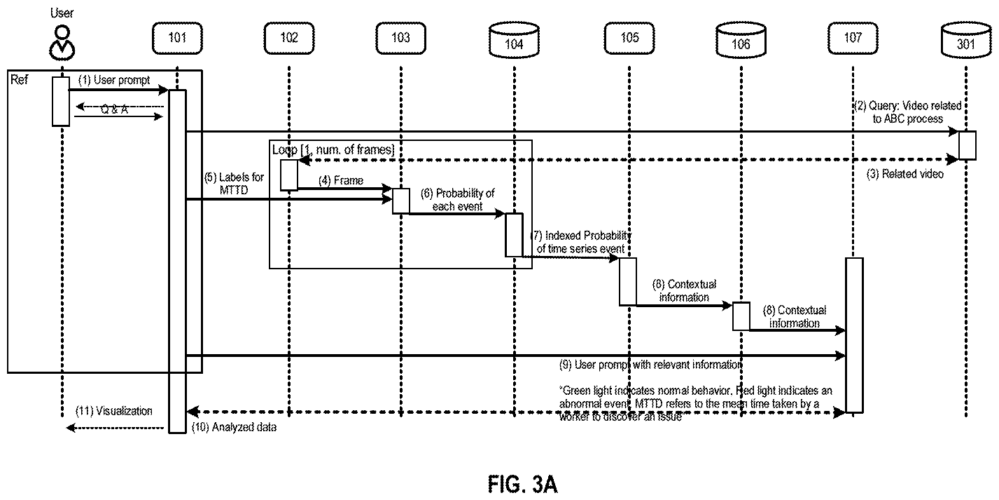

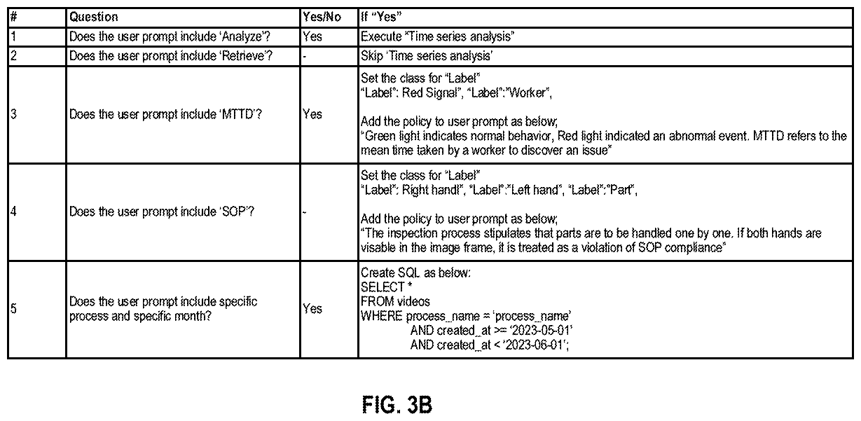

FIG. 3A illustrates a sequence diagram associated with the system described herein, in accordance with an example implementation. The externally referenced sections (“ref”) describe the preprocessing to add the information needed in the later stages of processing to the user prompts, which are ambiguous expressions.

In an example flow of FIG. 3A, at first a user provides a user prompt (1) to the UI 101. The UI 101 may execute a Q&A (Question and Answer) session to further garner information regarding the provided prompt. At 102, the query (2) is generated by the UI 101, which in this example is a video related to the ABC process, to the video data storage 301. The related video (3) is retrieved from the video data storage 301 and then processed by video frame extraction unit 102 to extract frames (4). Each of the extracted frames (4) is processed by the event probability calculation unit 103 to generate labels for MTTD (5). The frames and labels are processed by the event probability calculation unit 103 to determine the probability of each event. This process is reiterated for each frame.

The probability of each event is provided to the time series calculation unit 104 which is configured to determine an indexed probability of time series event (7). The indexed probability of time series event is processed by the contextual information calculation unit 105 to generate contextual information (8). Such contextual information is stored in a contextual information storage 106, to be processed by LLM-based analysis 107.

The LLM-based analysis 107 intakes contextual information (8) as well as the user prompt along with relevant information (9), and is configured to return analyzed data (10). In this example, the relevant information (9) included in the user prompt is that “Green light indicates normal behavior, Red light indicates an abnormal event. MTTD refers to the mean time taken by a worker to discover an issue”. The LLM-based analysis 107 returns the analyzed data (10) which is then provided as a visualization (11) from the user interface 101.

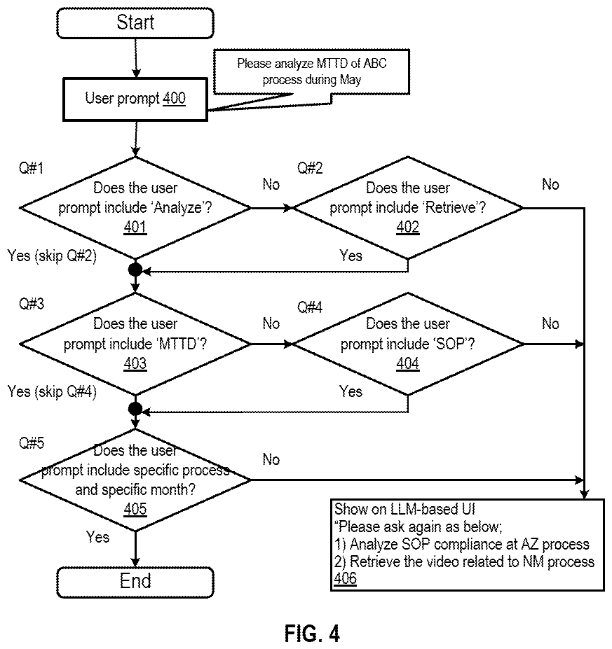

FIG. 3B illustrates an example question and answer tree to obtain relevant information, in accordance with an example implementation. FIG. 4 illustrates an example of pre-processing, in accordance with an example implementation. In the example of FIG. 4, several questions are asked to the information contained in the user prompt in the LLM-based UI to add the information necessary for each unit of processing in the later stage. In this example, questions #1-5 are implemented to enhance the RAG system to achieve relevant information, such as shown in the fourth column of FIG. 3B. The UI can re-ask the user in a pre-fixed formats when there is an unexpected prompt, but the present disclosure is not limited thereto, and other implementations may be utilized to facilitate the desired implementation.

As shown at FIG. 4, a user prompt 400 is provided, which in this example is “Please analyze MTTD of ABC process during May”. At 401, the pre-processing of FIG. 3B is executed starting from question #1, which is “Does the user prompt include ‘Analyze’?”. If so (Yes) then question #2 is skipped, otherwise (No) the flow proceeds to 402 to ask the second question. At 402, question #2 is asked, which is “Does the user prompt include ‘Retrieve’?” If so (Yes), then the flow proceeds to 403, otherwise (No) the flow proceeds to 406.

At 403, question #3 is asked, which is “Does the user prompt include ‘MTTD’?” If so (Yes), then the flow proceeds to 405, otherwise (No), then the flow proceeds to 404. At 404, question #4 is asked, which is “Does the user prompt include ‘SOP’?”. If so (Yes), then the flow proceeds to 405, otherwise (No), the flow proceeds to 406.

At 405, question #5 is asked, which is “Does the user prompt include specific process and specific month?” If so (Yes) then the flow ends, otherwise (No) the flow proceeds to 406. At 406, the flow generate Show on LLM-based UI to “Please ask again as below; 1) Analyze SOP compliance at AZ process 2) Retrieve the video related to NM process”.

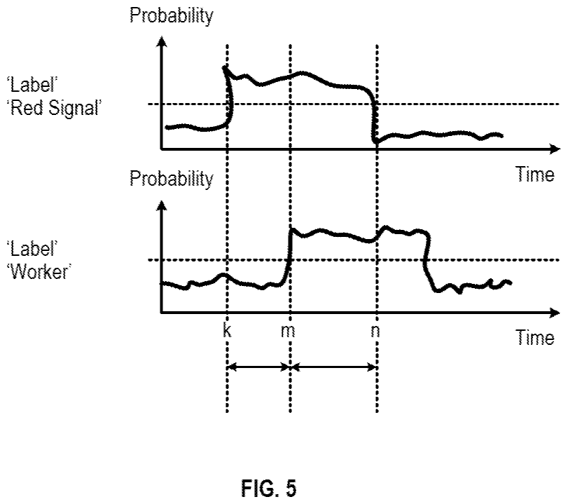

FIG. 5 illustrates the MTTD measurement being queried, in accordance with an example implementation. Specifically, FIG. 5 illustrates the MTTD measurement being queried by the user, by detecting changes in probability information from the past to the present that exceed a predetermined threshold in contextual information calculation unit 106.

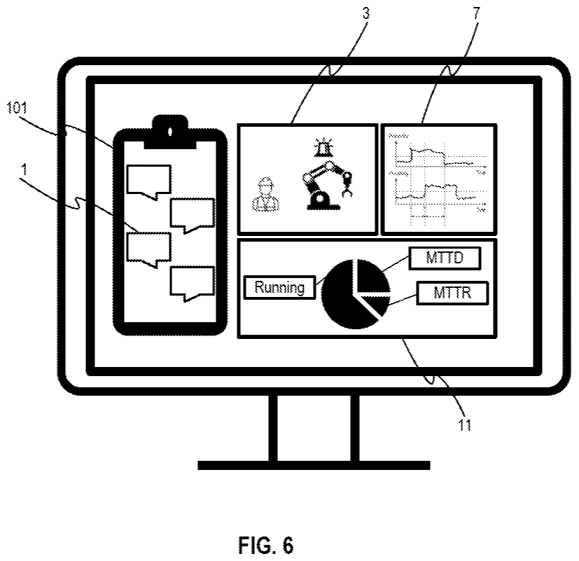

FIG. 6 illustrates an example of the user interface for the system for interactive time series analysis, in accordance with an example implementation. As illustrated in FIG. 6, the user interface can involve an LLM-based user interface 101 intakes user prompts (1) and can also display the relevant video data (3), the probability of each event (7), and the interactive response (11).

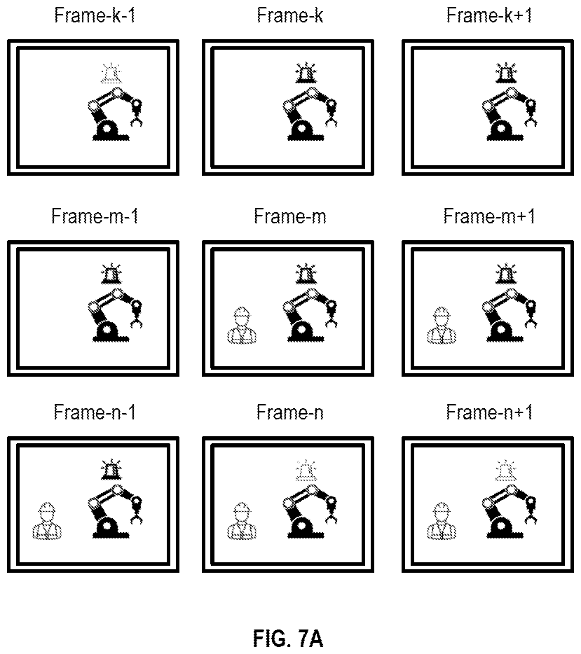

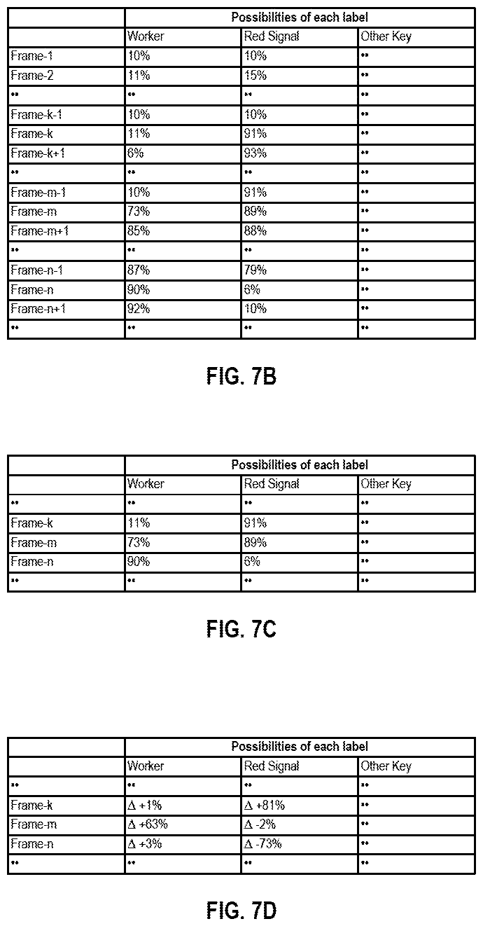

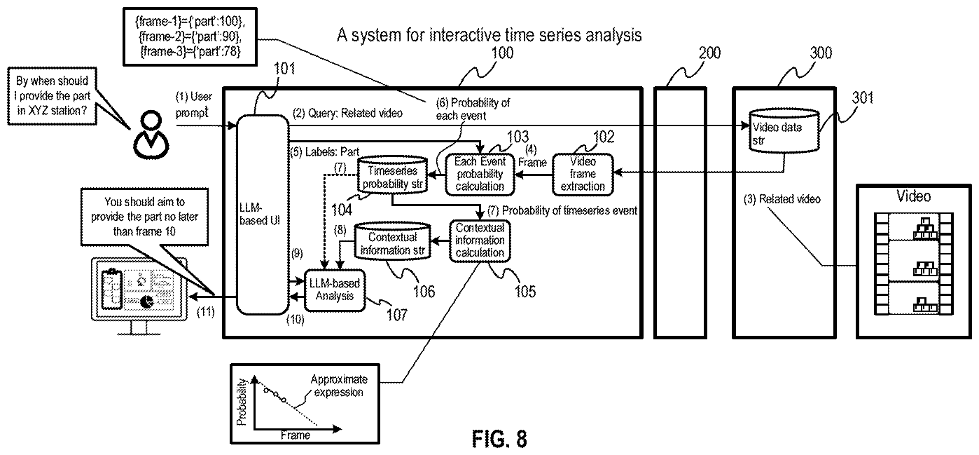

FIG. 7A illustrates an example of the execution of the contextual information calculation unit 105, in accordance with an example implementation. The example of FIG. 7A is an example execution in the MTTD case wherein the Red Signal is lit at exactly the center time k of Frame-k−1, Frame-k, and Frame-k+1; the Red Signal is turned on at the center time k of Frame-m−1, Frame-m, and At the center time m of Frame-m−1, Frame-m, Frame-m+1, the worker confirms that the Red Signal is turned on, and at the center time n of Frame-n−1, Frame-n, Frame-n+1, and the Red Signal is turned off and changes to a green signal. FIG. 7B shows the probability columns when this scene is textualized by the each event probability calculation unit 103, and FIGS. 7C and 7D show examples of calculations by the contextual information calculation unit 105. FIG. 7C shows the case where only frames with a large change in probability are extracted, and FIG. 7D shows the case where the change in probability from the previous frame is calculated and displayed.

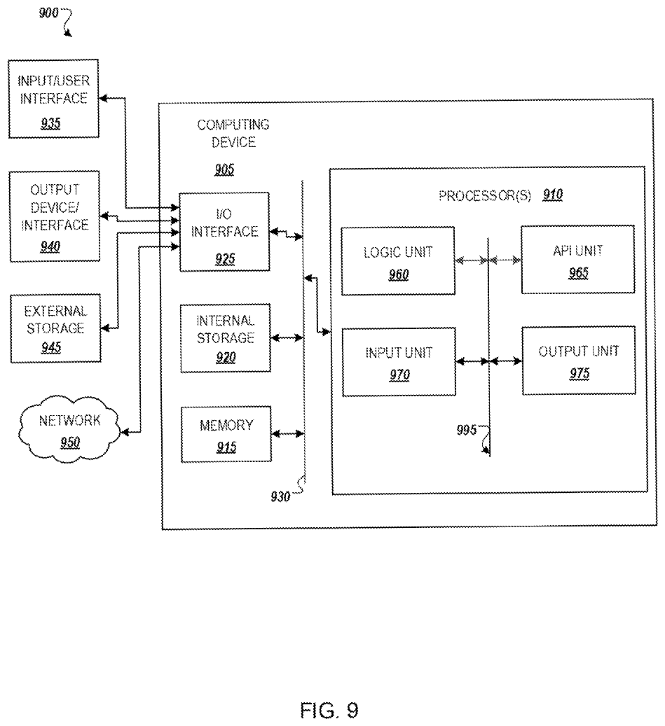

FIG. 8 illustrates another example implementation for an interactive timeseries system designed for inventory management within the XYZ process. This example use case illustrates how the system can detect the probability information of a part, identified with the classification label “Part,” and provides guidance on material delivery timings as well as future stockout warnings in the future, as well as other suggestions or action directives in accordance with the desired implementation.

A detailed description of each component's role in this use case is as follows.

User Prompt (1): A user asks the system, “By when should I provide the part in XYZ station?” This input initiates the analysis process.

LLM-based UI 101: The system's user interface, driven by a large language model (LLM), interprets the user prompt and determines if additional information is needed. It can engage in a Q&A if necessary to clarify or expand upon the user's request.

Query for Related Video (2): The UI sends out a query to retrieve video data related to the part in question from the large-scale data storage 300.

Large-scale Data Storage Component 300: This component stores extensive video data and other data, which includes footage of the XYZ process over time.

Video Frame Extraction 102: Once the related video data storage 301 is identified, this unit extracts frames from the video for analysis.

Frame and Event Probability Calculation 103 and time series probability storage 104: Individual frames (4), along with labels for the part (5), are processed to calculate the probability of each event (7) and the probability of time series events 104, utilizing time series probability strings (6).

Contextual Information calculation 105 and contextual information storage 106: The calculated probabilities and labels are combined with contextual information strings (8) to understand the event within its operational context comprehensively.

LLM-based Analysis 107: The LLM processes all the above information and performs a detailed analysis (9), which can include the part's approximate expression in terms of probability over time as visualized in the graph.

Interactive Response (10 & 11): Based on the analysis, the LLM-based UI provides an interactive response to the user, such as “You should aim to provide the part no later than frame 10,” guiding the user on optimal material delivery timing to prevent stockouts.

Each component works in concert to ensure that the system not only detects the current inventory status, but also predicts future needs, thereby enabling effective inventory management and optimization within the XYZ process. The system's ability to process and analyze video data through the integration of frame extraction, event probability calculation, and contextual analysis, culminating in an LLM-based predictive response, exemplifies a cutting-edge approach to managing parts and materials in industrial settings.

The example implementations described herein build on the seamless integration of CLIP and LLM technologies for interactive video analysis, as described. The system's capability to analyze video data with CLIP by identifying relevant objects and events, and the detailed process of passing information to LLM for generating contextually rich dialogue responses, provides a solid foundation. The emphasis on innovative integration of visual data analysis with natural language processing and retrieval-augmentation underlines the unique interactive and insightful analysis tool offered by the invention. The addition of preprocessing for data quality enhancement, RAG for complex query handling, and a feedback mechanism for model refinement further extends the system's capabilities for real-time monitoring, predictive maintenance, SOP compliance, and defect detection.

Example implementations can also consider prediction use cases based on multiple sets of data some coming from CLIP (either a keyword search or a similar image search), and other data coming from PLCs, and so on. This will be effective for events that cannot be resolved by image information alone.

For label selection, CLIP allows for long sentences rather than words, so that a “worker” organizing a package in an image can be labeled as a “worker organizing a package” by using the RAG system. By devising the flowchart described in FIG. 4, labeling can be optimized semi-automatically. It is possible to refer to the work procedures registered in PLM from the process name, and to base the labeling on the work procedures written in the work procedures.

FIG. 9 illustrates an example computing environment with an example computer device suitable for use in some example implementations, such as A system for interactive time series analysis, a database managing a plurality of videos. Computer device 905 in computing environment 900 can include one or more processing units, cores, or processors 910, memory 915 (e.g., RAM, ROM, and/or the like), internal storage 920 (e.g., magnetic, optical, solid state storage, and/or organic), and/or I/O interface 925, any of which can be coupled on a communication mechanism or bus 930 for communicating information or embedded in the computer device 905. I/O interface 925 is also configured to receive images from cameras or provide images to projectors or displays, depending on the desired implementation.

Computer device 905 can be communicatively coupled to input/user interface 935 and output device/interface 940. Either one or both of input/user interface 935 and output device/interface 940 can be a wired or wireless interface and can be detachable. Input/user interface 935 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 940 may include a display, television, monitor, printer, speaker, braille, or the like. In some example implementations, input/user interface 935 and output device/interface 940 can be embedded with or physically coupled to the computer device 905. In other example implementations, other computer devices may function as or provide the functions of input/user interface 935 and output device/interface 940 for a computer device 905.

Examples of computer device 905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 905 can be communicatively coupled (e.g., via I/O interface 925) to external storage 945 and network 950 for communicating with any number of networked components, devices, and systems, including one or more computer devices of the same or different configuration. Computer device 905 or any connected computer device can be functioning as, providing services of, or referred to as a server, client, thin server, general machine, special-purpose machine, or another label.

I/O interface 925 can include, but is not limited to, wired and/or wireless interfaces using any communication or I/O protocols or standards (e.g., Ethernet, 802.11x, Universal System Bus, WiMAX, modem, a cellular network protocol, and the like) for communicating information to and/or from at least all the connected components, devices, and network in computing environment 900. Network 950 can be any network or combination of networks (e.g., the Internet, local area network, wide area network, a telephonic network, a cellular network, satellite network, and the like).

Computer device 905 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 910 can execute under any operating system (OS) (not shown), in a native or virtual environment. One or more applications can be deployed that include logic unit 960, application programming interface (API) unit 965, input unit 970, output unit 975, and inter-unit communication mechanism 995 for the different units to communicate with each other, with the OS, and with other applications (not shown). The described units and elements can be varied in design, function, configuration, or implementation and are not limited to the descriptions provided. Processor(s) 910 can be in the form of hardware processors such as central processing units (CPUs) or in a combination of hardware and software units.

In some example implementations, when information or an execution instruction is received by API unit 965, it may be communicated to one or more other units (e.g., logic unit 960, input unit 970, output unit 975). In some instances, logic unit 960 may be configured to control the information flow among the units and direct the services provided by API unit 965, input unit 970, output unit 975, in some example implementations described above. For example, the flow of one or more processes or implementations may be controlled by logic unit 960 alone or in conjunction with API unit 965. The input unit 970 may be configured to obtain input for the calculations described in the example implementations, and the output unit 975 may be configured to provide output based on the calculations described in example implementations.

Processor(s) 910 can be configured to, for receipt of a query as shown at (2), calculate probability information of at least one object on each frame of a video from the plurality of videos related to the query as shown at (3) to (6); calculate a state of the at least one object for a specified time based on the probability information from past to the specified time as shown at (7); and input the state at the specified time to a large language model (LLM) configured to output an analysis and prediction in a natural language output responsive to the query as shown at (8) to (10).

Processor(s) 910 can be configured to calculate the state of the at least one object at the specified time by integrating past and present probability information as described with respect to FIGS. 1 and 2.

Depending on the desired implementation, the LLM can be configured to generate dialogue responses (11) based on input of the probability information and the state of the at least one object for the specified time.

Processor(s) 910 can be configured to calculate the state for the specified time by using a probability model that incorporates dynamic changes of the at least one object.

Processor(s) 910 can be configured to calculate the state for the specified time by prediction of future probability information, and facilitating analysis and prediction of future events from use of the future probability information as the input to the LLM as shown in FIG. 5.

Depending on the desired implementation, the LLM can be configured to dynamically adjust responses according to a context of generated dialogue responses and user requests for additional information as shown at (9) to (11).

Depending on the desired implementation, the LLM can be configured to output the prediction in the natural language output based on future probability information as one or more of warnings, suggestions, or action directives as shown in FIG. 8.

Processor(s) 910 can be configured to optimize label information through a pre-processing procedure before calculation of the probability information as shown at (5), thereby improving the accuracy of subsequent analysis and prediction.

Depending on the desired implementation, the LLM can be configured to execute a Retriever-Augmented Generation (RAG) based approach in response to the input to integrate contextual information from external knowledge bases as described herein.

Processor(s) 910 can be configured to execute a feedback mechanism to refine models used for calculation of the probability information and the state of the at least one object for the specified time from user interaction as shown at (10) and (11).

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to, optical disks, magnetic disks, read-only memories, random access memories, solid-state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored in the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A system for interactive time series analysis, comprising:
a database managing a plurality of videos;
a processor, configured to, for receipt of a query:
calculate probability information of at least one object on each frame of a video from the plurality of videos related to the query;
calculate a state of the at least one object for a specified time based on the probability information from past to the specified time; and
input the state at the specified time to a large language model (LLM) configured to output an analysis and prediction in a natural language output responsive to the query.

2. The system of claim 1, wherein the processor is configured to calculate the state of the at least one object at the specified time by integrating past and present probability information.

3. The system of claim 1, wherein the LLM is configured to generate dialogue responses based on input of the probability information and the state of the at least one object for the specified time.

4. The system of claim 1, wherein the processor is configured to calculate the state for the specified time by using a probability model that incorporates dynamic changes of the at least one object.

5. The system of claim 1, wherein the processor is configured to calculate the state for the specified time by prediction of future probability information, and facilitating analysis and prediction of future events from use of the future probability information as the input to the LLM.

6. The system of claim 1, wherein the LLM is configured to dynamically adjust responses according to a context of generated dialogue responses and user requests for additional information.

7. The system of claim 1, wherein the LLM is configured to output the prediction in the natural language output based on future probability information as one or more of warnings, suggestions, or action directives.

8. The system according to claim 1, wherein the processor is configured to optimize label information through a pre-processing procedure before calculation of the probability information.

9. The system of claim 1, wherein the LLM is configured to execute a Retriever-Augmented Generation (RAG) based approach in response to the input to integrate contextual information from external knowledge bases.

10. The system of claim 1, wherein the processor is configured to execute a feedback mechanism to refine models used for calculation of the probability information and the state of the at least one object for the specified time from user interaction.

11. A method for interactive time series analysis, comprising, for receipt of a query:
calculating probability information of at least one object on each frame of a video from a plurality of videos related to the query;
calculating a state of the at least one object for a specified time based on the probability information from past to the specified time; and
inputting the state at the specified time to a large language model (LLM) configured to output an analysis and prediction in a natural language output responsive to the query.

12. The method of claim 11, wherein the calculating the state of the at least one object at the specified time comprises integrating past and present probability information.

13. The method of claim 11, wherein the LLM is configured to generate dialogue responses based on input of the probability information and the state of the at least one object for the specified time.

14. The method of claim 11, wherein the calculating the state for the specified time comprising using a probability model that incorporates dynamic changes of the at least one object.

15. The method of claim 11, wherein the calculating the state for the specified time is conducted based on prediction of future probability information, and facilitating analysis and prediction of future events from use of the future probability information as the input to the LLM.

16. The method of claim 11, wherein the LLM is configured to dynamically adjust responses according to a context of generated dialogue responses and user requests for additional information.

17. The method of claim 11, wherein the LLM is configured to output the prediction in the natural language output based on future probability information as one or more of warnings, suggestions, or action directives.

18. The method of claim 11, further comprising optimizing label information through a pre-processing procedure before calculation of the probability information.

19. The method of claim 11, wherein the LLM is configured to execute a Retriever-Augmented Generation (RAG) based approach in response to the input to integrate contextual information from external knowledge bases.

20. The method of claim 11, further comprising executing a feedback mechanism to refine models used for calculation of the probability information and the state of the at least one object for the specified time from user interaction.
